(19) United States
(12) Patent Application Publication
(10) Pub. No.: US 2016/0128275 A1
(43) Pub. Date: May 12, 2016

(54) ROBOTIC MOWER CONTACT DETECTION SYSTEM

(71) Applicant: Deere & Company, Moline, IL (US)

(72) Inventor: David A. Johnson, Durham, NC (US)

(21) Appl. No.: 14/539,566

(22) Filed: Nov. 12, 2014

(51) Int. Cl. A01D 34/00; G05D 1/02

(52) U.S. Cl. CPC A01D 34/008; G05D 1/021; G05D 2201/0208

(57) ABSTRACT

A robotic mower contact detection system includes a flexible and deformable bumper, a force sensing element embedded in the bumper and providing electrical signals, and a vehicle control unit receiving the electrical signals from the force sensing element and reversing rotation of a pair of traction drive motors if the electrical signals meet specified criteria.

### FIELD OF THE INVENTION

This invention relates to robotic lawn mowers, and specifically to a robotic mower contact detection system.

### BACKGROUND OF THE INVENTION

Robotic mowers may be required to react to contact with an object, also referred to as contact detection or bump detection. Standards for robotic mowers specify limits on the forces that the mower can impart on a contact object (e.g., peak/impulse force, force over time) and specify the time when the mower must react to contact with an object.

For contact detection, some robotic mowers have used a floating shell surrounding the mower chassis that becomes displaced if an obstacle is encountered, and a Hall Effect sensor that detects shell movement. Floating shells are considered mechanically complex, prone to failure, and unsturdy.

Alternatively, some robotic mowers have used a soft front bumper along with one or more accelerometers mounted to the mower's outer shell. Accelerometers are less mechanically complex and costly, and more durable than floating shells. Accelerometers may detect obstacles when there is an impact, and spikes in accelerometer readings have been used to measure contact. However, noise on the accelerometer may be too high to obtain meaningful signals in outdoor environments or when the mower blades are activated. Impulse forces required for an accelerometer to detect a bump also may be too high for some robotic mower standards.

Some robotic mowers may use sudden drops in wheel speed or changes in the control effort required to maintain wheel speed as indications of a bump. These techniques may be sensitive to false positive detection if the robotic mower encounters small bumps or holes in the terrain. Additionally, these techniques may fail to detect bumps if the robotic mower is operating at low speeds. For example, at low speeds the wheel motor speed may not drop sufficiently and the control effort may not increase enough to detect bumps.

A robotic mower contact detection system is needed that is simple, reliable and sturdy. A robotic mower contact detection system is needed that is not subject to outside noise. A robotic mower contact detection system is needed that minimizes false positives and that can detect bumps at low speeds.

### SUMMARY OF THE INVENTION

A robotic mower contact detection system includes a force sensing element in a deformable bumper, with shock absorbing structures in front of and behind the force sensing element. The force sensing element produces detectable electrical signals to a vehicle control unit which reverses rotation of a pair of traction drive motors if the electrical signals meet specified criteria. The robotic mower contact detection system is simple, reliable and sturdy, is not subject to outside noise, minimizes false positives, and can detect bumps at low speeds.

### BRIEF DESCRIPTION OF THE DRAWINGS

FIG. 1 is a perspective view of a robotic mower with a contact detection system according to a first embodiment of the invention.

FIG. 2 is an exploded perspective view of a robotic mower contact detection system according to a first embodiment of the invention.

FIG. 3 is a cross section view of a robotic mower contact detection system according to a first embodiment of the invention.

### DESCRIPTION OF THE PREFERRED EMBODIMENT

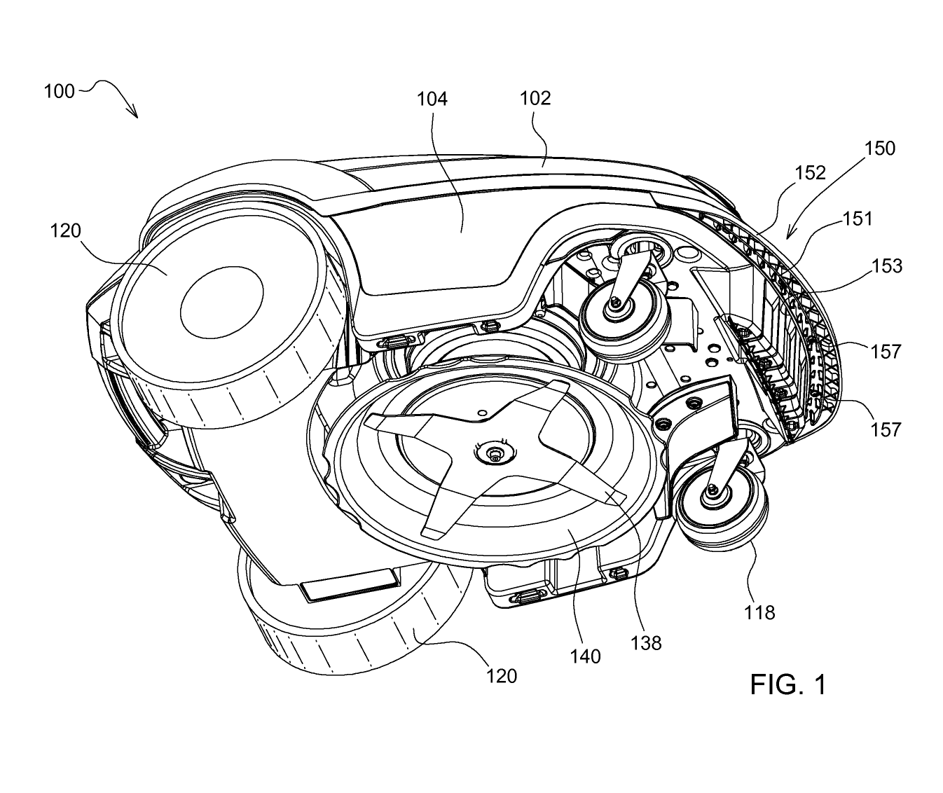

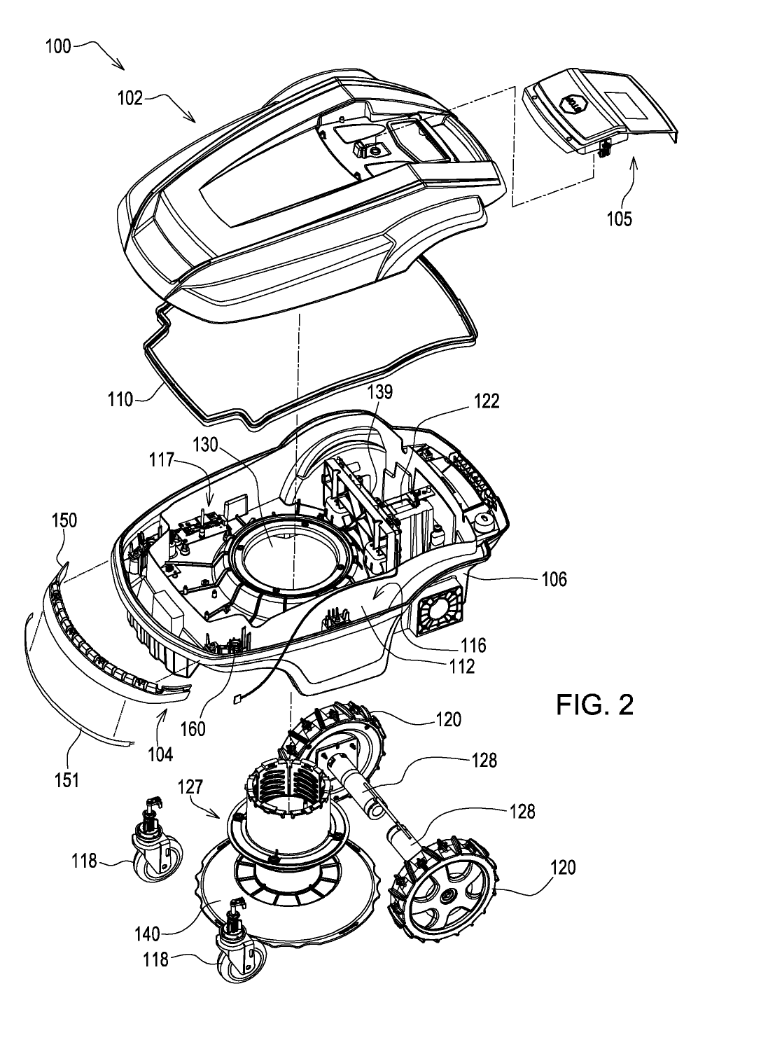

In the embodiment shown in FIGS. 1 and 2, robotic mower 100 may be powered by battery pack 122 that may be charged periodically using a charging station. Battery pack 122 may store electrical energy used to operate a pair of variable speed electric motors 128 to turn a pair of traction drive wheels 120, rotate cutting blade 138, and power vehicle control unit 139 that may be programmed to command electric traction wheel motors 128 and operate functions of the robotic mower. Each traction wheel motor may be a DC brushed or DC brushless motor that controls one of the wheels. The cutting blade may be supported by height of cut adjustment assembly 127 which may be mounted to the bottom chassis so that it may extend through height of cut adjustment assembly hole 130.

In one embodiment, top cover 102 may be removably attached and secured to bottom chassis 104. For example, the top cover may be secured to the bottom chassis with a plurality of mounting clips or fasteners extending between the bottom chassis and top cover, which may be tightened by threading or snap fit into nuts or retainers. The bottom chassis may have a pair of walls, an outer wall 106 and an inner wall 112, to define an outer cavity 116 and an inner cavity 117, as shown and described in U.S. Pat. No. 8,336,282 for Robotic Mower Housing assigned to Deere & Company. The bottom chassis also may include mounting brackets 160 for a pair of front caster wheels 118. Flexible elastomeric seal 110 may be positioned between the top cover and bottom chassis. Control panel 105 may be removably attached to the top cover, and the control panel may be connected to the vehicle control unit for an operator to enter various commands using a keypad. A seal may be provided between the control panel and the top cover. Additionally, a stop button may be provided on the control panel. The stop button may be connected to the vehicle control unit to command the traction wheel motors and blade motor to stop.

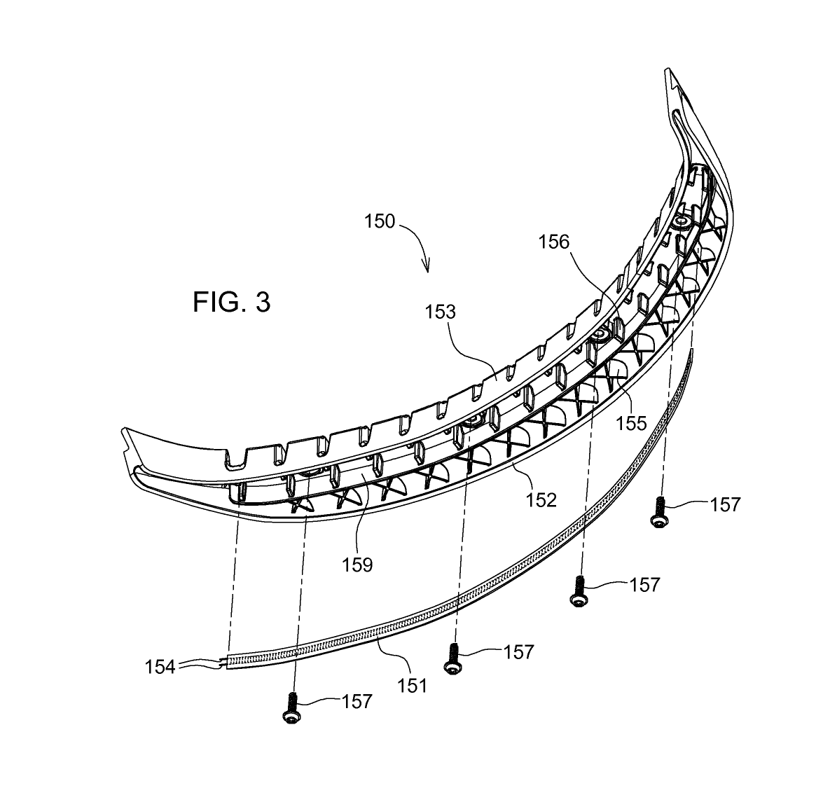

In one embodiment shown in FIGS. 1-3, the robotic mower contact detection system may include flexible and deformable bumper 150 which may be a generally U-shaped rubber member mounted to the front end of robotic mower 100. For example, the bumper may be attached to the front of the bottom chassis, wrapped around a forward portion of the bottom chassis adjacent and under the top cover. The bumper may be secured to the front end of the bottom chassis with mechanical fasteners 157, adhesives or retaining members. Optionally, the bumper also may be mounted to or extend around other parts of the robotic mower.

In one embodiment, the robotic mower contact detection system may include force sensing element 151 embedded or positioned inside bumper 150 between the front facing surface 152 and rear facing surface 153 of the bumper. For example, the force sensing element may be attached to the front of central rib 159. Alternatively, the force sensing element may be positioned between the bumper and the bottom chassis of the robotic mower. The force sensing element may be responsive to deformation of the bumper that results in force or pressure applied against the force sensing element. The force sensing element may produce detectable electrical signals to the vehicle control unit. For example, the force sensing element may change an electrical property such as inductance, capacitance or resistance.

In one embodiment, the force sensing element may be a force sensing resistor (FSR) that changes resistance in response to applied force and/or pressure. The resistance of the force sensing resistor may be related to the amount of force and/or pressure resulting from deformation of the bumper that imparts a force on the FSR which results in a change in the FSR's electrical resistance. The force sensing resistor may be in the form of a strip or sheet of sensing film with electrically conducting and non-conducting particles suspended in matrix. For example, the force sensing resistor may be a model 408 strip FSR from Interlink Electronics, Inc. having a width of about 15 mm and a thickness less than about 0.5 mm. A force applied to the force sensing resistor causes the particles to touch the conducting electrodes, changing the resistance of the film in a predictable manner. The electrodes of the force sensing resistor may be connected to a pair of male leads or pins 154 to vehicle control unit 139 having a resistance measuring circuit. One example of a resistance measuring circuit uses a step response technique including a capacitor that charges and/or discharges in a time that is proportional to the resistance of the FSR.

In one embodiment, the robotic mower contact detection system may include shock absorbing structures 155, 156 in front of and behind the force sensing element. The shock absorbing structures may be ribs that are integrally molded or formed as part of the rubber bumper, or other materials that may be inserted into the rubber bumper directly in front of and behind the force sensing element. The bumper and shock absorbing structures limit and delay the application of force that may be imparted to the force sensing element. More specifically, when the bumper initially contacts an object, the electric traction wheel motors 128 may continue rotating wheels 120. If the object is stationary and sufficient friction exists between the wheels and ground surface, the bumper may deform and the shock absorbing structures also may deform in response to the force against the bumper. The bumper and shock absorbing structures may continue to deform, without significant change in the force sensing element's resistance, until the amount of force against the bumper meets or exceeds a specified value. For example, a force of at least 15 Newtons may need to be applied against the bumper before the force sensing element's resistance declines significantly. Thus, the bumper and shock absorbing structures assure that forces to the bumper that are below a threshold are not detected by the force sensing element.

In one embodiment, the robotic mower contact detection system may include a vehicle control unit that receives input from the force sensing element if the shock absorbing structures apply force or pressure against the force sensing element. For example, the resistance of a force sensing resistor may decrease as the applied force increases. The vehicle control unit may include a circuit that determines if the resistance of the force sensing resistor meets or exceeds a specified value. The vehicle control unit may take multiple readings to eliminate false positives.

In one embodiment, the robotic mower contact detection system may include a vehicle control unit that may open or close a circuit in response to input from the force sensing element that meets or exceeds specified criteria. For example, the vehicle control unit may provide certain commands to the pair traction drive motors if input from the force sensing element satisfies certain predetermined force criteria. For example, if the robotic mower is moving forward and mowing, and the force sensing element detects a bump, the vehicle control unit may set the ground speed to a negative value so that the traction wheel motors rotate in reverse and back up the robotic mower. The vehicle control unit may specify a nominal speed in reverse that may be slower than the forward speed. Additionally, the vehicle control unit also may command the traction drive motors to drive the robotic mower at a target yaw angle or arc away from the bump. Similarly, if the robotic mower is moving forward during a boundary following, homing or clean up pass, and the force sensing element detects a bump, the vehicle control unit may set the ground speed to a negative value, set a yaw angle to get around the object, before returning to the original route. The vehicle control unit also may command cutting blade 138 to stop rotation.

In a second alternative embodiment, the force sensing element may be a strip or sheet of electrically conductive foam placed between two non-contacting conductive surfaces of the bumper. When the foam is compressed, the resistance may decrease. Resistance may be measured across the two conductive surfaces that sandwich the foam.

In a third alternative embodiment, the force sensing element may be a membrane switch used to close an air gap along a series of resistors. The membrane switch may be installed in the front bumper and closed with deformation of the bumper. The resistance may be related to the point of contact of the series of resistors to the ground plane.

Having described the preferred embodiment, it will become apparent that various modifications can be made without departing from the scope of the invention as defined in the accompanying claims.

1. A robotic mower contact detection system, comprising:
a flexible and deformable bumper;
a force sensing element embedded in the bumper and providing electrical signals; and
a vehicle control unit receiving the electrical signals from the force sensing element and reversing rotation of a pair of traction drive motors if the electrical signals meet specified criteria.

2. The robotic mower contact detection system of claim 1 wherein the force sensing element is a force sensing resistor.

3. The robotic mower contact detection system of claim 1 further comprising shock absorbing structures in the flexible deformable bumper in front of and behind the force sensing element.

4. The robotic mower contact detection system of claim 1 wherein the flexible and deformable bumper is a U-shaped rubber member.

5. A robotic mower contact detection system, comprising:
a force sensing element positioned between shock absorbing structures in a bumper; the force sensing element responsive to deformation of the bumper and the shock absorbing structures; the force sensing element producing detectable electrical signals to a vehicle control unit; the vehicle control unit reversing rotation of a pair of traction drive motors if the electrical signals meet a specified criteria.

6. The robotic mower contact detection system of claim 5 wherein the shock absorbing structures are in front of and behind the force sensing element.

7. The robotic mower contact detection system of claim 5 wherein the force sensing element is a force sensing resistor in the form of a strip.

8. The robotic mower contact detection system of claim 5, wherein the bumper is a rubber U-shaped member mechanically secured to the robotic mower.

9. A robotic mower contact detection system, comprising:
a rubber bumper attached to the front of a robotic mower;
a force sensing resistor in the form of a strip positioned inside the bumper between a front facing surface and a rear facing surface of the bumper, with shock absorbing structures in front of and behind the force sensing resistor; and
a vehicle control unit connected to the force sensing resistor and receiving electrical signals from the force sensing resistor based on the amount of a force applied to the force sensing resistor.

10. The robotic mower contact detection system of claim 9 wherein the vehicle control unit causes a pair of traction drive motors to reverse if the electrical signals meet certain criteria.

11. The robotic mower contact detection system of claim 9 wherein the vehicle control unit causes a blade motor to stop if the electrical signals meet certain criteria.
